(19) United States
(12) Patent Application Publication
(10) Pub. No.: US 2018/0373269 A1
(43) Pub. Date: Dec. 27, 2018

(54) SYSTEMS AND METHODS USING A BACKUP NAVIGATIONAL TOOL FOR UNMANNED AERIAL VEHICLES DELIVERING MERCHANDISE

(71) Applicant: Walmart Apollo, LLC, Bentonville, AR (US)

(72) Inventor: Robert L. Cantrell, Herndon, VA (US)

(21) Appl. No.: 16/015,466

(22) Filed: Jun. 22, 2018

Related U.S. Application Data
(60) Provisional application No. 62/524,802, filed on Jun. 26, 2017.

(51) Int. Cl. G05D 1/10; B64C 39/02; G01C 21/00; G01S 19/48; G06K 9/00

(52) U.S. Cl. CPC G05D 1/101; B64C 39/024; G01C 21/005; B64C 2201/146; G06K 9/0063; B64C 2201/128; B64C 2201/145; G01S 19/48

(57) ABSTRACT

In some embodiments, apparatuses and methods are provided herein useful to delivering merchandise using unmanned aerial vehicles (UAVs). In some embodiments, there is provided a system including: a UAV having a motorized flight system, a storage area, a transceiver, an imaging, and a GPS tracking device; a memory device for storing position coordinates of the UAV; a flight simulator database including storing geographic and landscape features along the UAV's flight path; and a control circuit configured to: navigate the UAV using GPS, store position coordinates, capture image sequences of the geographic and landscape features, and if the GPS fails to provide accurate position information, communicate with the flight simulator database, calculate a predicted position for the UAV, compare the image sequences with images from the flight simulator database, and determine the actual position of the UAV if individual images in the image sequences match images from the flight simulator database.

### CROSS-REFERENCE TO RELATED APPLICATION

This application claims the benefit of U.S. Provisional Application No. 62/524,802, filed Jun. 26, 2017, which is incorporated by reference in its entirety herein.

### TECHNICAL FIELD

This invention relates generally to unmanned aerial vehicles (UAVs), and more particularly, to UAVs delivering merchandise to customers.

### BACKGROUND

In the retail sector, one important challenge is the delivery of merchandise to customers. Currently, one delivery mechanism that is being developed is the use of unmanned aerial vehicles (UAVs) to deliver the merchandise to customers. There are clear advantages to using UAVs to make deliveries, including avoidance of vehicular traffic and reduced delivery times. However, the use of UAVs to make deliveries also presents its own challenges, including navigation of the UAVs to the delivery location.

In one aspect, UAVs may be navigated to the delivery location using GPS as a primary navigation tool. It is desirable to have a backup navigational tool that can be used if the GPS becomes non-functional or otherwise fails to operate during the delivery flight. In fact, certain governmental regulations may now require or may soon require certain types of backup navigational mechanisms for certain aerial vehicles. Accordingly, it is desirable to develop redundant navigational mechanisms for UAVs that can be used when the GPS primary navigational tool is not available or not operational.

### BRIEF DESCRIPTION OF THE DRAWINGS

Disclosed herein are embodiments of systems, apparatuses and methods pertaining to delivering merchandise using UAVs. This description includes drawings, wherein:

FIG. 1 is a schematic diagram in accordance with some embodiments;

FIG. 2 is a block diagram in accordance with some embodiments;

FIG. 3 is a flow diagram in accordance with some embodiments; and

FIG. 4 is a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to delivering merchandise using unmanned aerial vehicles (UAVs). In some embodiments, there is provided a system comprising: an unmanned aerial vehicle (UAV) comprising: a motorized flight system configured to facilitate flight of the UAV along a flight path from a starting location to a delivery location; a storage area configured to hold merchandise for delivery; a transceiver configured for wireless communication; an imaging sensor configured to capture a plurality of images; a GPS tracking device configured to determine position coordinates of the UAV to navigate to the delivery location; a memory device configured to store the position coordinates of the UAV; a flight simulator database configured for storing geographic and landscape features along at least a portion of the UAV's flight path; a control circuit configured to: navigate the UAV from the starting location along the flight path to the delivery location using the GPS tracking device as a first navigation mechanism; store the position coordinates of the UAV at predetermined time intervals; capture image sequences of geographic and landscape features along at least a portion of the UAV's flight path using the imaging sensor; if the GPS tracking device is not determining position coordinates along the flight path: communicate with the flight simulator database to access the geographic and landscape features along at least a portion of the UAV's flight path; calculate a predicted position for the UAV based on the position coordinates of the UAV; compare the image sequences from the imaging sensor with geographic and landscape features from the flight simulator database within a predetermined area about the predicted position; and determine the actual position of the UAV if individual images in the image sequences match geographic and landscape features from the flight simulator database.

Further implementations of these embodiments are provided. For example, in some implementations, the control circuit may be configured to: if the GPS tracking device is not determining position coordinates along the flight path: compare the image sequences from the imaging sensor with geographic and landscape features from the flight simulator database; and navigate the UAV toward the delivery location based on matching individual images in the image sequences with geographic and landscape features from the flight simulator database as a second navigation system. In some implementations, the control circuit may be configured to: if the GPS tracking device is not determining position coordinates along the flight path:

compare the image sequences from the imaging sensor with geographic and landscape features from the flight simulator database not to exceed a predetermined maximum length of time; and if no match is determined, navigate the UAV back along the flight path to the starting location. In some implementations, the control circuit may be configured to: if the GPS tracking device is not determining position coordinates along the flight path: compare the image sequences from the imaging sensor with geographic and landscape features from the flight simulator database not to exceed a predetermined maximum length of time; and if no match is determined, communicate with and await instructions from a human pilot at a remote navigational control center for navigating the UAV. In some implementations, the control circuit may be configured to: if the GPS tracking device is not determining position coordinates along the flight path and no match is determined: await instructions from the human pilot for navigating the UAV for a predetermined time interval; and if instructions are not received within the predetermined time interval: capture a plurality of images of the geographic and landscape features about the UAV; determine if a subset of images matches predetermined conditions indicating level terrain suitable for landing the UAV; and navigate the UAV to a landing location corresponding to one of the subset of images. In some implementations, the predetermined conditions comprise a flat green zone or flat brown zone. In some implementations, the control circuit may be configured to determine a match when a predetermined number of features of the image sequences from the imaging sensor correspond to geographic and landscape features from the flight simulator database. In some implementations, the control circuit may be configured to: if the GPS tracking device is not determining position coordinates along the flight path and no match is determined: identify a landmark within a predetermined area of the predicted position of the UAV; navigate the UAV in the direction of the landmark from the predicted position; compare the image sequences from the imaging sensor with a known image of the landmark to determine the actual position. In some implementations, the control circuit may be configured to transmit geographic and landscape features from the flight simulator database corresponding to the UAV's position to a device of a user receiving delivery of merchandise transported by the UAV.

In another form, there is provided a method of delivering merchandise using unmanned aerial vehicles, the system comprising: providing an unmanned aerial vehicle (UAV) comprising: a motorized flight system configured to facilitate flight of the UAV along a flight path from a starting location to a delivery location; a storage area configured to hold merchandise for delivery; a transceiver configured for wireless communication; an imaging sensor configured to capture a plurality of images; a GPS tracking device configured to determine position coordinates of the UAV to navigate to the delivery location; providing a flight simulator database containing stored geographic and landscape features along at least a portion of the UAV's flight path; by a control circuit: navigating the UAV from the starting location along the flight path to the delivery location using the GPS tracking device as a first navigation mechanism; storing the position coordinates of the UAV at predetermined time intervals; capturing image sequences of geographic and landscape features along at least a portion of the UAV's flight path using the imaging sensor; if the GPS tracking device is not determining position coordinates along the flight path: communicating with the flight simulator database to access the geographic and landscape features along at least a portion of the UAV's flight path; calculating a predicted position for the UAV based on the position coordinates of the UAV; comparing the image sequences from the imaging sensor with geographic and landscape features from the flight simulator database within a predetermined area about the predicted position; and determining the actual position of the UAV if individual images in the image sequences match geographic and landscape features from the flight simulator database.

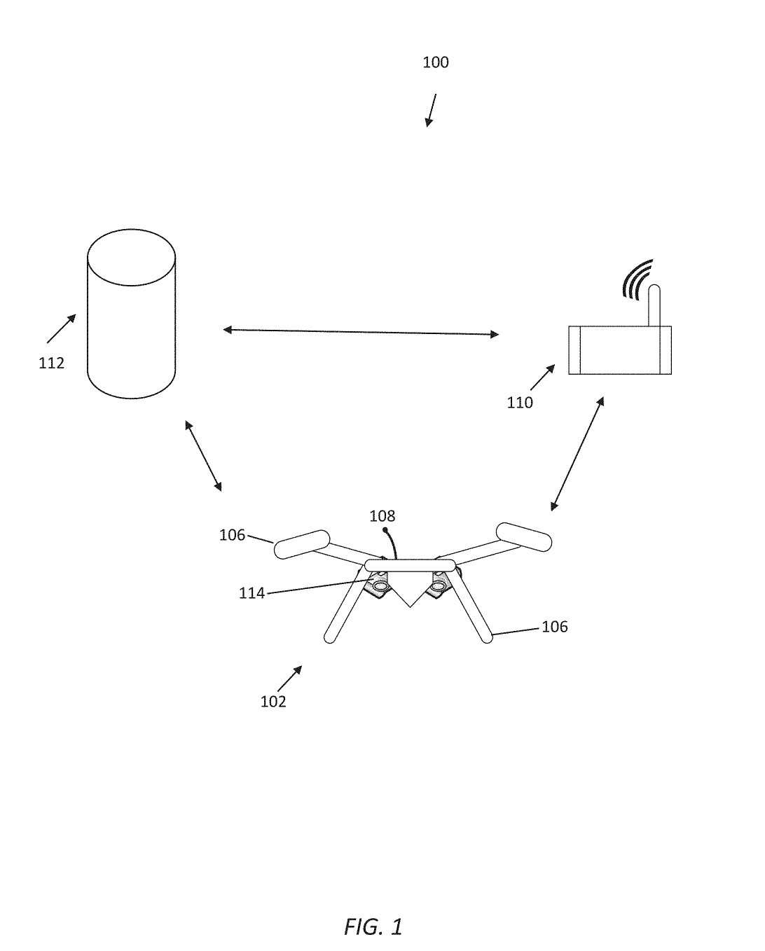

Referring to FIG. 1, there is shown a schematic representation of a delivery system 100 using a UAV as a delivery mechanism with several redundant forms of navigation. In other words, the delivery system generally has one or more back-up navigational tools. In many circumstances, it is contemplated that the UAV will be able to make the delivery by flying along the flight path using GPS. However, in some circumstances, the GPS may be non-operational or may be malfunctioning. In such circumstances, it is contemplated that the UAV may be able to complete the delivery by navigation involving comparing images of the geographic or landscape features below the UAV with geographic and landscape features from a flight simulator database. In this regard, it is contemplated that the flight simulator database will have stored therein information about the known geographic and landscape features that are visible along the flight path. Further, it is contemplated that the flight simulator database can be accessed and used to generate images such as might be seen from the UAV in certain positions in flight, such as may depend, for example, on the altitude, orientation, and bearing of the UAV.

The system 100 includes a UAV 102 configured to deliver merchandise by flying along a flight path from a starting location to a delivery location. It is generally contemplated that the UAV will deliver merchandise from a retailer to a delivery location (such as the customer's residence). The UAV 102 may travel from a starting location at a retail store, a delivery vehicle (that may transport multiple UAVs 102 to certain locations), a product distribution center, or any other suitable location. The UAV 102 may then fly along a flight path to a delivery location, such as a customer residence, customer business location, or other customer designated pick up location.

It is generally contemplated that the UAV 102 includes certain conventional components that allow it to transport merchandise. For example, the UAV 102 includes a motorized flight system 106 configured to facilitate flight of the UAV 102. In one form, it is generally contemplated that this motorized flight system 106 includes props, a navigational guidance system coupled to the props, a power source to enable operation of the props and navigational guidance system, and landing gear. The UAV 102 also includes a transceiver 108 configured for wireless communication, such as for communication with a command and control center 110 and/or with a flight simulator database 112 (which may be at the command and control center 110 or at a separate location).

Further, the UAV 102 includes an optical (or imaging) sensor 114 configured to capture a plurality of images. The optical sensor 114 may be any of various types of cameras, video devices, etc., that may be configured to capture still images and/or image sequences. As one example, it is contemplated that these images may be transmitted to the command and control center 110 to be compared with images from the flight simulator database 112 to facilitate navigation (either to the delivery location or some other location). As another example, it is contemplated that these images may be transmitted to the command and control center 110 to enable a pilot to navigate the UAV 102 in certain circumstances. In this example, the optical sensor 114 may capture images of the landing area about the delivery location to allow a pilot to choose a suitable landing area and land the UAV 102.

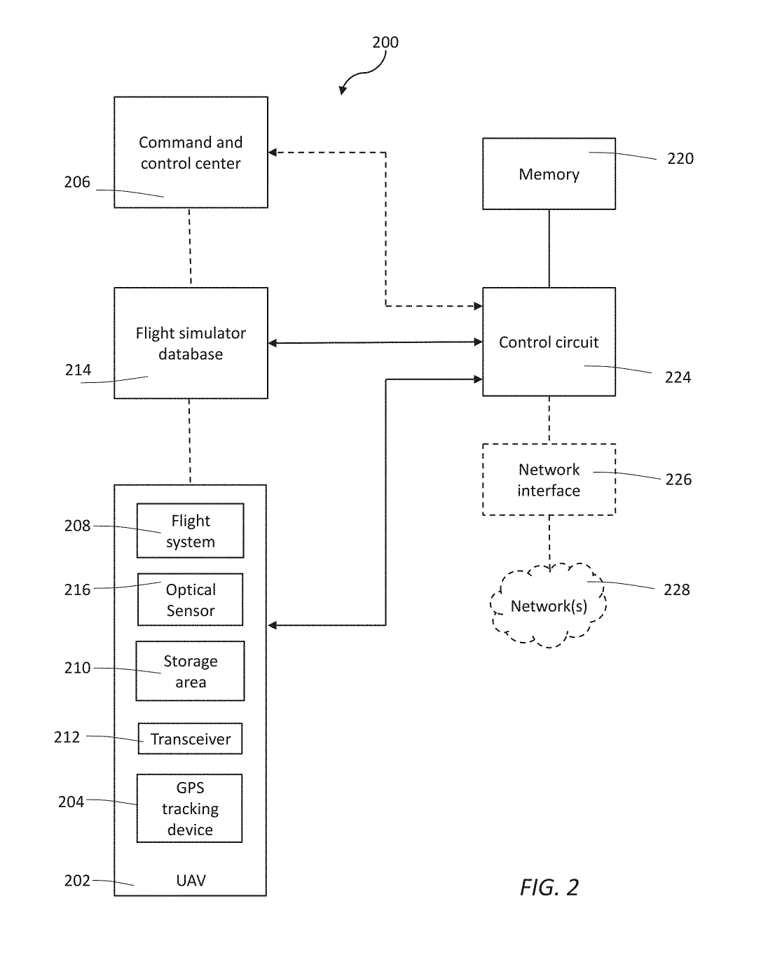

Referring to FIG. 2, there is shown a system 200 for the delivery of merchandise, such as from a retailer to a customer. The system 200 includes a UAV 202 that uses multiple, redundant navigational tools to complete the delivery. In most circumstances, the UAV 202 may be able to transport merchandise autonomously along a flight path to a destination (or to a waypoint near the delivery location) using a GPS tracking device 204. In other words, the GPS tracking device 204 operates as the primary navigational tool. However, in some circumstances, the GPS tracking device 204 may malfunction or may otherwise be unable to facilitate navigation of the UAV 202. In these circumstances, it is contemplated that the UAV 202 may complete the delivery (or may take alternative flight action) by using a secondary, back-up navigational tool, involving comparing real time images with flight simulator database images. As described further below, the system 200 may include a remote navigational center 206 (or command and control center 206) that controls, in whole or in part, the operation of the UAV 204. A human pilot or operator at the command and control center 206 may act as a tertiary, back-up navigational option (in case the first two options are not sufficient).

The UAV 202 includes various components in order to fly along a flight path to deliver merchandise to the desired destination location. The UAV 204 includes a motorized flight system 208 configured to facilitate flight of the UAV 204. For example, the motorized flight system 208 may be in the form of propellers, a drive mechanism, a motor, landing gear, and a power source (such as a battery).

The UAV 202 also includes a storage area 210 for holding the merchandise item(s) being delivered. The merchandise items may be of any type suitable for delivery, such as, for example, clothing, grocery, sporting goods, general retail merchandise, etc. In addition, the storage area 210 may be refrigerated and/or insulated for the delivery of perishable items, such as frozen or refrigerated grocery items. Also, the storage area 210 may be of any of various sizes and shapes. It may be relatively small for delivery of a single item per delivery and/or to conserve battery power. Alternatively, it may be relatively large to allow the storage of multiple merchandise items for delivery to different destinations.

In addition, the UAV 202 includes a transceiver 212 or other two-way communication device for wireless communication. It is generally contemplated that the UAV 202 will communicate with the command and control center 206 and/or the flight simulator database 214. For example, the UAV 202 may be in communication with a human pilot or operator at the command and control center 206 for human control of the UAV 202 in certain circumstances. The UAV 202 may also be in communication with the flight simulator database 214 to allow comparison of real time images with images generated from information stored in the database 214.

The UAV 202 also includes sensors(s) facilitating flight of the UAV 202 and delivery of merchandise items. It is generally contemplated that the UAV 202 may include conventional position and movement sensors (such as compasses, gyroscopes, accelerometers, altimeters, etc.) that provide information to assist in navigation of the craft. The UAV 202 further includes an optical/imaging sensor 216 configured to capture a plurality of images. The optical/imaging sensor 216 may be any of various types of video/camera devices. It is contemplated that the imaging sensor 216 will capture images at various stages of the flight, such as during landing at the destination location (when expert guidance may be required to navigate the UAV 202) and possibly when using the images for navigation (if the GPS tracking device 204 is not functioning to facilitate navigation).

As indicated, the UAV 204 also includes the GPS tracking device 204 for determining position coordinates of the UAV 204 to facilitate navigation to the delivery location (which may be a waypoint near the final landing location). It is further contemplated that the GPS tracking device 204 is coupled to a memory device 220 that stores the position coordinates of the UAV 202 during the flight, and any of various types of conventional memory devices for storing data may be used. It is generally contemplated that the position coordinates of the UAV 202 during the flight may be determined and stored continuously or at certain specific time intervals, such as every five minutes. The memory device 220 may be located locally at the UAV 202 or remotely from the UAV 202 (and wirelessly coupled to the UAV 202).

The system 200 further includes the flight simulator database 214 containing stored geographic and landscape features along at least a portion of the UAV's flight path (and preferably along the entire flight path). The flight simulator software and database 214 are utilized to generate simulated views corresponding to positions along the flight path. In one form, the flight simulator database 214 is remote from the UAV 202 and is wirelessly coupled to the UAV 202. However, in another form, the flight simulator database 214 may be located at the UAV 202 itself. As addressed further below, it is generally contemplated that the flight simulator database 214 will be used as a back-up navigation mechanism in case the GPS tracking device 204 malfunctions.

In addition, the system 200 includes a control circuit 224 that generally controls operation and navigation of the UAV 202. Being a “circuit,” the control circuit 224 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 224 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 224 is configured (for example, by using corresponding programming as will be well understood by those skilled in the art) to carry out one or more of the steps, actions, and/or functions described herein.

The control circuit 224 operably couples to the memory 220. This memory 220 may be integral to the control circuit 224 or can be physically discrete (in whole or in part) from the control circuit 224, as desired. This memory 220 can also be local with respect to the control circuit 224 (where, for example, both share a common circuit board, chassis, power supply, and/or housing) or can be partially or wholly remote with respect to the control circuit 224 (where, for example, the memory 220 is physically located in another facility, metropolitan area, or even country as compared to the control circuit 224).

This memory 220 can serve, for example, to non-transitorily store the computer instructions that, when executed by the control circuit 224, cause the control circuit 224 to behave as described herein. As used herein, this reference to “non-transitorily” will be understood to refer to a non-ephemeral state for the stored contents (and hence excludes when the stored contents merely constitute signals or waves), rather than volatility of the storage media itself, and hence includes both non-volatile memory (such as read-only memory (ROM)) as well as volatile memory (such as an erasable programmable read-only memory (EPROM).)

In this example, the control circuit 224 may also operably couple to a network interface 226. So configured, the control circuit 224 can communicate with other elements (both within the system 200 and external thereto) via the network interface 226. Network interfaces, including both wireless and non-wireless platforms, are well understood in the art and require no particular elaboration here. This network interface 226 can compatibly communicate via whatever network or networks 228 may be appropriate to suit the particular needs of a given application setting. Both communication networks and network interfaces are well understood areas of prior art endeavor and therefore no further elaboration will be provided here in those regards for the sake of brevity.

The control circuit 224 is configured to navigate the UAV 202 from the starting location along the flight path to the delivery location (which may be a waypoint near the final customer location) using the GPS tracking device 204 as a primary navigational tool. It further stores the position coordinates of the UAV at certain time intervals, such as every five minutes. It is generally contemplated that these position coordinates will usually be determined by the GPS tracking device 204 during ordinary operation. The control circuit 224 is further configured to capture image sequences of geographic and landscape features along at least a portion of the UAV's flight path using the imaging sensor 216. It may be configured to capture such images continuously during flight or only upon occurrence of certain events or at certain points of the flight, such as upon landing or upon malfunctioning of the GPS tracking device 204.

If the GPS tracking device 204 is not determining position coordinates along the flight path, i.e., is malfunctioning or for some other reason is unable to determine the coordinates, the control circuit 224 switches over to a back-up navigational tool. In one form, it is contemplated that the control circuit 224 will access and use the flight simulator database 214 as a back-up tool. More specifically, the control circuit 224 communicates with the flight simulator database 214 to access the geographic and landscape features along the UAV's flight path, calculates a predicted position for the UAV 202 based on the past stored position coordinates of the UAV 202, and compares the image sequences from the imaging sensor 216 with geographic and landscape features from the flight simulator database 214 within a certain area about the predicted position. In other words, the control circuit 224 examines and compares the image data generated from the flight simulator database 214 that corresponds to the expected position of the UAV 202 based on the past flight data. The control circuit 224 then determines the actual position of the UAV 202 if it determines a match of individual images in the image sequences with geographic and landscape features from the flight simulator database 214.

In one form, if its actual position is determined, the UAV 202 may then navigate to the delivery location using image matching. In other words, the UAV 202 may complete the delivery mission using the back-up navigational tool. More specifically, if the GPS tracking device 218 is not determining position coordinates along the flight path, the control circuit 224 may compare the image sequences from the imaging sensor 216 with geographic and landscape features from the flight simulator database 214 and navigate the UAV 202 toward the delivery location based on matching individual images in the image sequences with geographic and landscape features from the flight simulator database 214.

This image matching may be conducted according to various image processing methods and image recognition software and simply requires sufficient matching of some of the features of the images to suggest a reliable identification. It does not require a precise one-to-one match of all parts of the images. In other words, the control circuit 224 may compare some or all parts and features of captured images to the flight simulator generated images, and if there is a certain minimal correspondence, a match may be determined. More specifically, the control circuit 224 may be configured to determine a match when a certain number of features of the image sequences from the imaging sensor 216 correspond to geographic and landscape features from the flight simulator database 214. In one form, the optical/imaging sensor 216 has sufficient color and darkness discrimination that may be useful in matching images, such as in the color and shading analysis of pixels.

Based on sensors providing flight information—altitude, attitude, direction, and velocity—the simulator may be configured to present a map of what the world around the UAV 202 should look like. The flight simulator and database 214 may use the general position of the UAV 202 to create a virtual/simulated image of the corresponding ground. These images may be overlaid with and compared to actual video feeds from the UAV 202. This approach involves marrying the flight simulator software and database 214 covering a given region with actual flight data from the UAV 202. In one form, this approach may utilize flight simulator maps that are programmed into and generated by flight simulators. Once certain flight information is known and inputted, such as speed, altitude, etc., simulated views can be generated.

Further, the imaging sensor 216 may be configured to identify certain specific fairly defined edges, such as may indicate roads, buildings, structures, bridges, lakes, etc. Arrangements of these fairly defined edges may be compared to arrangements of geographic and landscape features in the flight simulator database 214 to try to determine a match. It is contemplated that this approach may be better suited for certain geographic regions, such as urban areas rather than rural areas, and therefore may be more appropriate for certain geographies and certain types of deliveries.

Further, in one form, it is contemplated that the flight simulator database 214 may be used as a cross-check on the accuracy of the GPS tracking device 218. For example, the control circuit 224 may conduct periodic or continuous matching of the video feed to the simulator software (according to some frame rate). If there is an inconsistency between the GPS and the image matching, the control circuit 224 may then perform a diagnostic on the GPS tracking device 218 to determine the accuracy of its functioning.

If the GPS is not working and no match is determined, i.e., no position identification is made, the UAV 202 may navigate back to its starting location. In other words, in one form, if neither navigational tool is providing needed navigation information, the default response may be to instruct the UAV 202 to return to its starting location (rather than completing the delivery mission). More specifically, if the GPS tracking device 204 is not determining position coordinates along the flight path, the control circuit 224 may compare the image sequences from the imaging sensor with geographic and landscape features from the flight simulator database 214 repetitively over a certain time period or for a certain number of times to try to determine a match, but if no match is determined, may navigate the UAV 202 back along the flight path to the starting location. In one form, the UAV 202 may reverse its flight path back to the starting location based on past sensor readings, such as, for example, by dead reckoning.

Alternatively, in one form, the UAV 202 may await instructions from a human pilot or operator if both GPS and image matching/identification are not working. In other words, a human pilot or operator may act as a tertiary navigational tool if the first two navigational tools are not operational. More specifically, if the GPS tracking device 204 is not determining position coordinates along the flight path, the control circuit 224 may be configured to compare the image sequences from the imaging sensor 216 with geographic and landscape features from the flight simulator database 214 for a predetermined length of time (or a predetermined number of times), and then if no match or identification is determined, communicate with and await instructions from a human pilot at a remote navigational control center 206 for navigating the UAV 202. So, in one form, if after a certain amount of time, both the primary and secondary navigational tools are not available, then the tertiary navigation tool (a human pilot) is used.

Further, the UAV 202 may determine a landing location if GPS, image matching and identification, and a human pilot are not available. In other words, if none of the three navigational tools are available/operational, the UAV 202 may determine a landing location. More specifically, if the GPS tracking device 204 is not determining position coordinates along the flight path and no match is determined, the control circuit 224 is configured to await instructions from the human pilot for navigating the UAV for a certain time interval, and if instructions are not received within the time interval, to capture a plurality of images of the geographic and landscape features about the UAV 202, to determine if a subset of images matches predetermined conditions indicating level terrain suitable for landing the UAV 202, and to navigate the UAV 202 to a landing location corresponding to one of the subset of images. In one form, the wait time interval may be based on the power source level, i.e., battery level, and the UAV 202 may determine a landing location once battery level reaches a certain minimum threshold level. In other words, the UAV 202 may try to determine a landing location before its battery level is no longer sufficient to keep it in the air.

In addition, the terrain suitable for landing the UAV 202, i.e., the landing zone, may be determined based on various criteria and conditions suggesting a landing zone that will likely result in little or no damage to the UAV 202. For example, in one form, these conditions may be based, at least in part, on the color and evenness of terrain detected by the imaging sensor 216, such as suggesting a flat green zone or flat brown zone. These criteria may seek to have the UAV 202 avoid certain regions, such as blue zones indicating water or such as rocky terrain, that might lead to damage to the UAV 202. So, in one form, the control circuit 224 is configured to compare the images from the imaging sensor 216 to desired landing zones, such as flat green and brown zones, and select the landing zone based on images satisfying these conditions.

In another form, it is contemplated that landmarks may be used to determine the UAV's 202 position when the GPS tracking device 204 is not working. In other words, the UAV 202 may navigate to an expected location of a known landmark to determine the position of the UAV 202. If the UAV 202 can be navigated in the general direction of the known landmark such that it gets close to the landmark, the UAV's position may be determined. More specifically, if the GPS tracking device 204 is not determining position coordinates along the flight path and no match is determined, the control circuit 224 may be configured to identify a landmark within a certain area of the predicted position of the UAV 202, navigate the UAV 202 in the direction of the landmark from the predicted position, and compare the image sequences from the imaging sensor 216 with a known image of the landmark to determine the actual position.

Also, during ordinary operation, it is generally contemplated that the position of the UAV 202 may be made accessible to a customer receiving delivery of the merchandise from the UAV 202. In this way, the customer can await the delivery and collect it from the landing location or might otherwise prepare for delivery of the merchandise. In other words, the customer may use a user device (such as a smartphone, laptop, table, or other computing device) to access real time data about the progress of the delivery (such as actual video feed images directly from the imaging sensor 216 or the UAV 202 or images from the flight simulator database 214 corresponding to the real time position of the UAV 202). During ordinary operation, this real time position is determined by the GPS tracking device 204. More specifically, the control circuit 224 may be configured to transmit actual images from the imaging sensor 216 (or to transmit geographic and landscape features from the flight simulator database 214 corresponding to the UAV's position) to a device of a user receiving delivery of merchandise transported by the UAV 202. In one form, the customer/user may be able to access a software application on their device to receive the real time position of the UAV 202.

In one form, the flight simulator software and database could 214 use position information from the GPS to create a virtual image of the corresponding ground. In other words, this approach may use a virtual (or simulated) feed to show the progress of the merchandise. This particular approach would not show the actual surroundings, such as by a camera or video apparatus, but instead shows a virtual projection that may include the virtual surroundings. The virtual projection may be similar to that used with a flight simulator. This virtual feed produces a more accurate and easy to interpret representation of where the UAV 202 is and its arrival time. It may provide a better representation than a real-time video by making important landmarks more distinct and by showing projections of landmark information, such as street names, which would not be found in a standard real-time video.

This tracking feature is directed generally to monitoring the progress of the package/merchandise delivery. For example, when a retailer is making a rush delivery to a customer, it may be important to have real time feedback regarding the progress of the delivery. The desire to know where the merchandise is at a given moment may arise when employing a UAV 202 both because orders delivered by such means may be tagged for rush delivery and because the customer may need to be available for pickup when the UAV 202 arrives.

This tracking feature involves signaling a smart device of the customer/user with GPS data and/or images of geographic and landscape features generated from the flight simulator database 214 corresponding to the real time position of the UAV 202. In addition, the data feed may include other statistics, such as speed of travel and the estimated time of arrival of the UAV 202. The customer may receive the link to the feed when placing the order, or the customer may receive a tracking feed when the UAV 202 is launched. The link may last until the UAV 202 delivers the merchandise. This feature helps customers be there when a package is delivered, and it also helps the customer prepare for arrival.

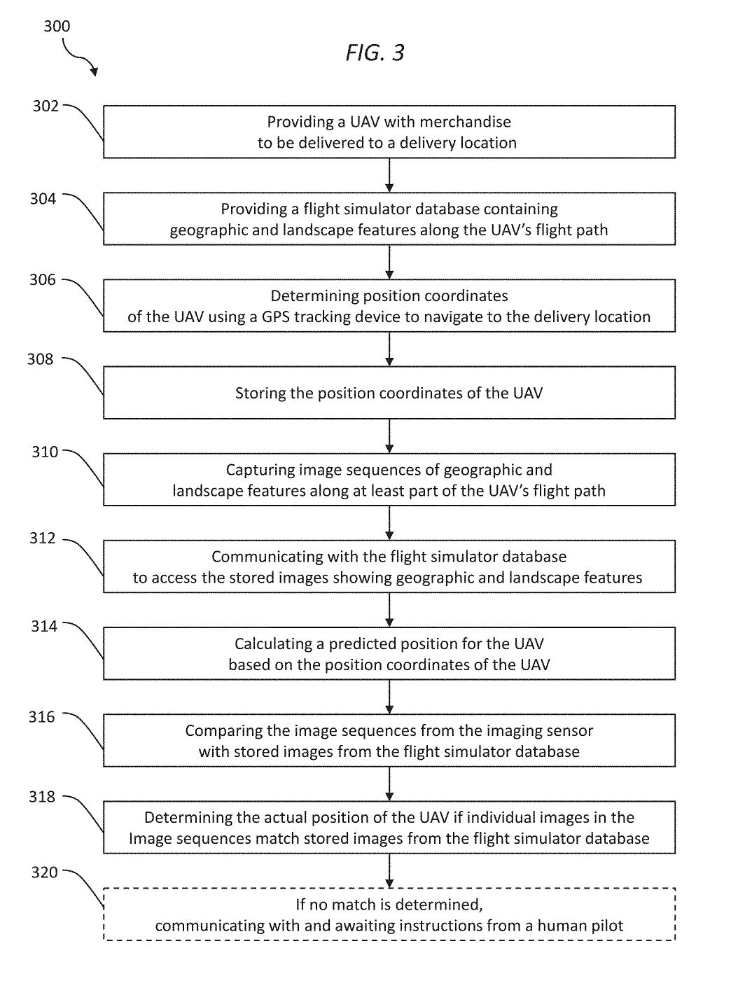

Referring to FIG. 3, there is shown a method 300 for the delivery of merchandise using a UAV, such as from a retailer to a customer. The method 300 makes use of a UAV and multiple, redundant navigational tools to be available and possibly used during the delivery. The method 300 generally uses GPS as the primary navigational tool. If the GPS is non-operational or cannot determine the UAV's position, the method 300 makes use of a secondary, back-up navigational tool that involves comparing real time images with images generated from flight simulator software and database. Finally, the method 300 may make use of a human pilot or operator as a tertiary, back-up navigational tool.

At block 302, a UAV transporting the merchandise item is provided for delivery to a delivery location. It is generally contemplated that the UAV will include components needed for performing the delivery, including a motorized flight system to facilitate flight of the UAV, a storage area for holding the merchandise item, a transceiver for wireless communication, an imaging/optical sensor for capturing images and other sensor(s) for flying along a delivery flight path and a GPS tracking device for determining position coordinates of the UAV. These components may be those described above with respect to systems 100 and 200.

At block 304, a flight simulator database is provided having information regarding geographic and landscape features along the UAV's flight path. It is generally contemplated that the images will be generated from the flight simulator software and database and used in connection with the secondary, back-up navigational tool. It is generally contemplated that the flight simulator database will be remote from the UAV, although it may also be physically located at the UAV. The flight simulator database may be located at a navigational control center (or command and control center) for the UAV or at some other remote physical location. The flight simulator database may be the database described above with respect to systems 100 and 200.

At block 306, position coordinates of the UAV are determined using the GPS tracking device to navigate to the delivery location. The position coordinates may be determined continuously or at certain fixed time intervals, such as every minute. In one form, it is generally contemplated that the position coordinates may be used to predict a probable position of the UAV if the GPS stops functioning. This predicted position may be used, in conjunction with images generated from the flight simulator database, to determine the actual position. At block 308, the position coordinates of the UAV are stored.

At block 310, image sequences of the geographic and landscape features are captured along at least part of the UAV's flight path. These image sequences may be captured in various ways. For example, the imaging sensor may capture continuous video along the entire flight path, may capture still images or short video at certain time intervals during the flight, or may be limited to capturing images when it is determined that the GPS is not functioning. Any of various imaging/optical sensors may be used, but it is generally desirable to use an imaging sensor with sufficient discrimination and possibly color/shading capability so as to allow for image comparison with the flight simulator database.

At block 312, it is contemplated that the GPS is not working to provide position coordinates to allow for navigation. For example, a certain time period may be set in which the GPS can determine position coordinates, and if the GPS is not able to do so, then to proceed to the secondary, back-up navigational tool. As shown in this block, there is communication with the flight simulator database to generate images showing geographic and landscape features.

At block 314, a predicted position for the UAV is calculated based on the position coordinates of the UAV. It is generally contemplated that the past flight positions of the UAV (when the GPS was working) may be used to predict the current flight position of the UAV. This predicted position may be used to narrow down the amount of information from the flight simulator database along the flight delivery path that needs to be used for comparison purposes. For example, locations within a certain distance (such as five miles) from the predicted position may be collected and analyzed for comparison with the actual images from the UAV.

At block 316, image sequences from the imaging sensor are compared with stored images from the flight simulator database (assuming the GPS is not working). In some forms, it is completed that the GPS is continuously or periodically checked to see it has since become functional, and if so, navigation may continue using the GPS. Assuming the GPS is still not functional, the image comparison may be conducted according to any of various conventional image processing techniques so as to identify a correspondence between some of the features of the images. As addressed above with respect to system 200, this comparison and matching simply requires sufficient matching of some of the features of the images to suggest a reliable identification.

At block 318, the actual position of the UAV is determined if individual images in the image sequences match stored images from the flight simulator database. In other words, if there is a sufficient correspondence of one or more features of the images, the actual position of the UAV is determined. At this point, the secondary, back-up tool may be used to navigate the UAV to various destinations. For example, the UAV may be navigated to the intended delivery location (which may include a waypoint near the customer's location), may be navigated back to the starting location, or may be navigated to an alternative location.

At block 320, if no match is determined, the UAV may communicate with and await instructions from a human pilot/operator. In other words, if the first two navigational tools are non-functional, i.e., the GPS and the flight simulator database, the method 300 may proceed to the third navigational tool. The human pilot may guide the UAV to any desired location, such as the delivery location, starting location, or to an alternative landing location.

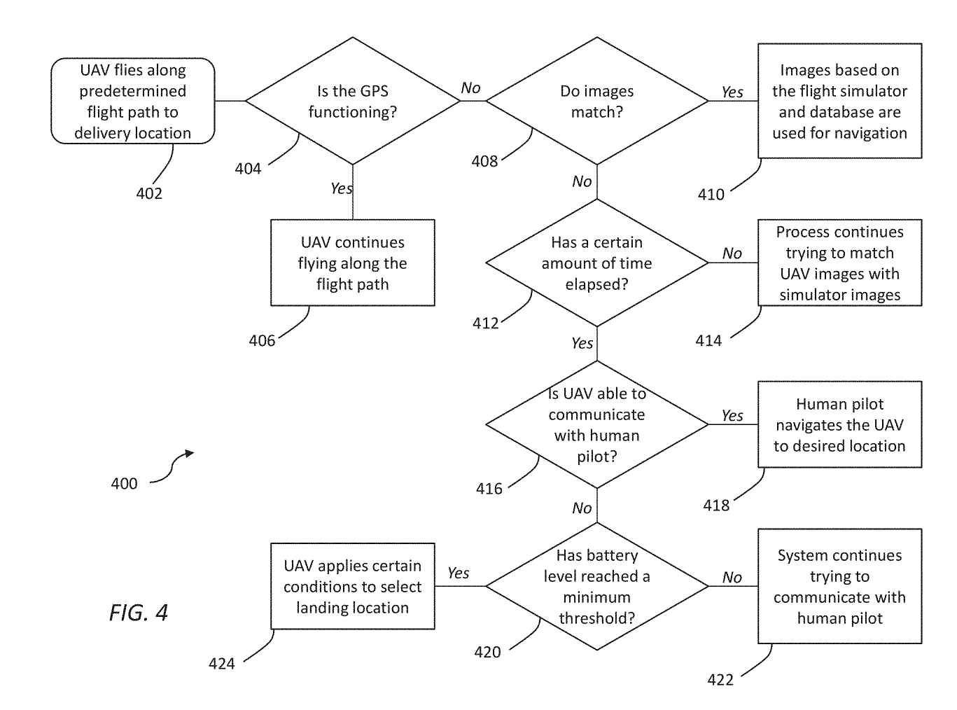

Referring to FIG. 4, there is shown a process 400 for delivering merchandise using a UAV with multiple navigational tools. The process 400 shows one possible algorithm with specific decisions made during the process 400. The process 400 generally contemplates the use of a UAV with components as described above. In this example, during ordinary operation, the UAV uses a GPS tracking device to determine its position and facilitate navigation. However, if the GPS is not working, the process 400 will then go through several decision points to determine how to proceed.

At block 402, the UAV travels along its flight path to the delivery location. For example, the delivery location may be a customer's residence or business address or may be a waypoint located nearby. As described above, during ordinary operation, the UAV includes a GPS tracking device for navigation. At block 404, the UAV continually monitors to detect if the GPS tracking device is working/functioning in an expected manner and providing reasonable position information. At block 406, if the GPS is functioning, the UAV will continue to fly along the delivery route. If the GPS functions for the entire flight, the UAV could arrive at the delivery location, and in one form, a human operator can guide the UAV to a landing location to complete the delivery.

At block 408, it has been determined that the GPS is not functioning properly. At this point, it is contemplated that there may be a certain wait time that must elapse (such as, for example, five minutes) before the process 400 will switch to the secondary, back-up navigational tool. This wait time is used to confirm that the GPS malfunction is more than temporary such that switching to the secondary, back-up navigational tool is warranted. It is further contemplated that the status of the GPS will be periodically or continually monitored such that it will again become the primary form of navigation if it resumes functioning properly.

At block 408, the process 400 switches to the secondary, back-up navigational tool. As addressed above, the UAV includes an optical/imaging sensor to capture images of the geographic and landscape features below the UAV. Further, the UAV wirelessly communicates and accesses a flight simulator database for generating images along the flight path. A comparison of the captured images and flight simulator software/database images is undertaken to try to establish a match of sufficient features to identify the UAV's actual position.

At block 410, a match is established. The images generated from the flight simulator software and database may then be used as the basis for navigation of the UAV. In this circumstance, the UAV may navigate to one of various locations. It may navigate to the delivery location to complete the delivery mission, or alternatively, it may navigated back to the starting location. Other destinations are also possible, such as navigating to a home base nearest the UAV's position.

At block 412, a match has not been established, and the UAV's position has not been determined. In this form, it is generally contemplated that the process 400 will continue to compare captured images with flight simulator images to try to determine the UAV position. Here, it is contemplated that a certain amount of comparison time is allowed so as to provide a reasonable opportunity to establish a match (such as, for example, 15 minutes). At block 414, within this comparison time, the process 400 will continue trying to match the UAV's captured images with flight simulator images. The process 400 will continue trying to make use of the secondary, back-up navigational tool.

At block 416, the time allotted for comparison has elapsed. At this point, it is concluded that the process 400 will not be able to make use of the secondary, back-up navigational tool and that it should proceed to the tertiary, back-up navigational tool, i.e., a human pilot/operator. The UAV will attempt to wirelessly communicate with navigational control center (command and control center) where a human pilot may be available. In one form, it is contemplated that the UAV may simply hover in place until it is able to establish communication. At block 418, if communication with a human pilot can be established, the human pilot can then navigate the UAV to a desired location. This desired location may be any of various locations, such as the delivery location, the starting location, a landing location near the UAV, a nearby home base, or any alternative desired location.

At block 420, the UAV has not been able to establish communication with a human pilot. There may be any of various reasons why the UAV is unable to establish communication, such as malfunctioning communication hardware or human pilots not being available because they are handling other tasks. At block 422, it is generally contemplated that the UAV will continue with efforts to establish communication until its battery level reaches a certain minimum threshold. At block 424, if the battery level reaches the minimum threshold, the UAV will apply certain conditions to select a landing location. For example, the UAV may look for green or brown flat zones suggesting a suitable landing location that will result in little or no damage to the UAV. It is desirable to have the UAV land before the battery becomes so depleted that there is insufficient battery power remaining to allow the UAV to land.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for delivery of merchandise using unmanned aerial vehicles, the system comprising:
an unmanned aerial vehicle (UAV) comprising:
a motorized flight system configured to facilitate flight of the UAV along a flight path from a starting location to a delivery location;
a storage area configured to hold merchandise for delivery;
a transceiver configured for wireless communication;
an imaging sensor configured to capture a plurality of images;
a GPS tracking device configured to determine position coordinates of the UAV to navigate to the delivery location;
a memory device configured to store the position coordinates of the UAV;
a flight simulator database configured for storing geographic and landscape features along at least a portion of the UAV's flight path;
a control circuit configured to:
navigate the UAV from the starting location along the flight path to the delivery location using the GPS tracking device as a first navigation mechanism;
store the position coordinates of the UAV at predetermined time intervals;
capture image sequences of geographic and landscape features along at least a portion of the UAV's flight path using the imaging sensor;
if the GPS tracking device is not determining position coordinates along the flight path:
communicate with the flight simulator database to access the geographic and landscape features along at least a portion of the UAV's flight path;
calculate a predicted position for the UAV based on the position coordinates of the UAV;
compare the image sequences from the imaging sensor with geographic and landscape features from the flight simulator database within a predetermined area about the predicted position; and
determine the actual position of the UAV if individual images in the image sequences match geographic and landscape features from the flight simulator database.

2. The system of claim 1, wherein the control circuit is configured to:
if the GPS tracking device is not determining position coordinates along the flight path:
compare the image sequences from the imaging sensor with geographic and landscape features from the flight simulator database; and
navigate the UAV toward the delivery location based on matching individual images in the image sequences with geographic and landscape features from the flight simulator database as a second navigation system.

3. The system of claim 1, wherein the control circuit is configured to:
if the GPS tracking device is not determining position coordinates along the flight path:
compare the image sequences from the imaging sensor with geographic and landscape features from the flight simulator database not to exceed a predetermined maximum length of time; and
if no match is determined, navigate the UAV back along the flight path to the starting location.

4. The system of claim 1, wherein the control circuit is configured to:
if the GPS tracking device is not determining position coordinates along the flight path:
compare the image sequences from the imaging sensor with geographic and landscape features from the flight simulator database not to exceed a predetermined maximum length of time; and
if no match is determined, communicate with and await instructions from a human pilot at a remote navigational control center for navigating the UAV.

5. The system of claim 4, wherein the control circuit is configured to:
if the GPS tracking device is not determining position coordinates along the flight path and no match is determined:
await instructions from the human pilot for navigating the UAV for a predetermined time interval; and
if instructions are not received within the predetermined time interval:
capture a plurality of images of the geographic and landscape features about the UAV;
determine if a subset of images matches predetermined conditions indicating level terrain suitable for landing the UAV; and
navigate the UAV to a landing location corresponding to one of the subset of images.

6. The system of claim 5, wherein the predetermined conditions comprise a flat green zone or flat brown zone.

7. The system of claim 1, wherein the control circuit is configured to determine a match when a predetermined number of features of the image sequences from the imaging sensor correspond to geographic and landscape features from the flight simulator database.

8. The system of claim 1, wherein the control circuit is configured to:
if the GPS tracking device is not determining position coordinates along the flight path and no match is determined,
identify a landmark within a predetermined area of the predicted position of the UAV;
navigate the UAV in the direction of the landmark from the predicted position;
compare the image sequences from the imaging sensor with a known image of the landmark to determine the actual position.

9. The system of claim 1, wherein the control circuit is configured to transmit geographic and landscape features from the flight simulator database corresponding to the UAV's position to a device of a user receiving delivery of merchandise transported by the UAV.

10. A method of delivering merchandise using unmanned aerial vehicles, the method comprising:
providing an unmanned aerial vehicle (UAV) comprising:
a motorized flight system configured to facilitate flight of the UAV along a flight path from a starting location to a delivery location;
a storage area configured to hold merchandise for delivery;
a transceiver configured for wireless communication;
an imaging sensor configured to capture a plurality of images;
a GPS tracking device configured to determine position coordinates of the UAV to navigate to the delivery location;
providing a flight simulator database containing stored geographic and landscape features along at least a portion of the UAV's flight path;
by a control circuit:
navigating the UAV from the starting location along the flight path to the delivery location using the GPS tracking device as a first navigation mechanism;
storing the position coordinates of the UAV at predetermined time intervals;
capturing image sequences of geographic and landscape features along at least a portion of the UAV's flight path using the imaging sensor;
if the GPS tracking device is not determining position coordinates along the flight path:
communicating with the flight simulator database to access the geographic and landscape features along at least a portion of the UAV's flight path;
calculating a predicted position for the UAV based on the position coordinates of the UAV;
comparing the image sequences from the imaging sensor with geographic and landscape features from the flight simulator database within a predetermined area about the predicted position; and
determining the actual position of the UAV if individual images in the image sequences match geographic and landscape features from the flight simulator database.

11. The method of claim 10, further comprising, by the control circuit:
if the GPS tracking device is not determining position coordinates along the flight path:
comparing the image sequences from the imaging sensor with geographic and landscape features from the flight simulator database; and
navigating the UAV toward the delivery location based on matching individual images in the image sequences with geographic and landscape features from the flight simulator database as a second navigation system.

12. The method of claim 10, further comprising, by the control circuit:
if the GPS tracking device is not determining position coordinates along the flight path:
comparing the image sequences from the imaging sensor with geographic and landscape features from the flight simulator database not to exceed a predetermined maximum length of time; and
if no match is determined, navigating the UAV back along the flight path to the starting location.

13. The method of claim 10, further comprising, by the control circuit:
if the GPS tracking device is not determining position coordinates along the flight path:
comparing the image sequences from the imaging sensor with geographic and landscape features from the flight simulator database not to exceed a predetermined maximum length of time; and
if no match is determined, communicating with and await instructions from a human pilot at a remote navigational control center for navigating the UAV.

14. The method of claim 13, further comprising, by the control circuit:
if the GPS tracking device is not determining position coordinates along the flight path and no match is determined:
awaiting instructions from the human pilot for navigating the UAV for a predetermined time interval; and
if instructions are not received within the predetermined time interval:
capturing a plurality of images of the geographic and landscape features about the UAV;
determining if a subset of images matches predetermined conditions indicating level terrain suitable for landing the UAV; and
navigating the UAV to a landing location corresponding to one of the subset of images.

15. The method of claim 14, wherein the predetermined conditions comprise a flat green zone or flat brown zone.

16. The method of claim 10, further comprising, by the control circuit:
determining a match when a predetermined number of features of the image sequences from the imaging sensor correspond to geographic and landscape features from the flight simulator database.

17. The method of claim 10, further comprising, by the control circuit:
if the GPS tracking device is not determining position coordinates along the flight path and no match is determined,
identifying a landmark within a predetermined area of the predicted position of the UAV;
navigating the UAV in the direction of the landmark from the predicted position;
comparing the image sequences from the imaging sensor with a known image of the landmark to determine the actual position.

18. The method of claim 10, further comprising, by the control circuit:
transmitting geographic and landscape features from the flight simulator database corresponding to the UAV's position to a device of a user receiving delivery of merchandise transported by the UAV.
